(19) United States
(12) Patent Application Publication
(10) Pub. No.: US 2011/0116882 A1
(43) Pub. Date: May 19, 2011

(54) Inner and outer thread tapping tool

(76) Inventor: Mark Chen, Taichung (TW)

(21) Appl. No.: 12/590,889

(22) Filed: Nov. 16, 2009

(51) Int. Cl. B23G 1/26; B25B 13/46

(52) U.S. Cl. 408/123; 470/207; 81/63.2

(57) ABSTRACT

A thread tapping tool includes a housing, an inner thread tapping device and an outer thread tapping device each having a gear wheel for changeably engaging into the housing, a lock device for detachably locking either of the gear wheels to the housing, and a switch device having a pivotal pawl for engaging with either of the gear wheels and for controlling the driving directions of the gear wheels by the housing, and for allowing the inner thread tapping device and the outer thread tapping device to selectively tap or form an inner thread in a work piece with a tapping mandrel or to selectively tap or form an outer thread in the shaft members or the other work pieces.

### BACKGROUND OF THE INVENTION

1. Field of the Invention

The present invention relates to a thread tapping tool, and more particularly to a thread tapping tool including a combination or structure for threading or tapping either the inner thread or the outer thread on the fasteners, and for allowing the inner thread tapping device or the outer thread tapping device to be easily and quickly attached to or disengaged from the tool housing and to be easily operated by the users.

2. Description of the Prior Art

Typical thread tapping tools comprise a mandrel or tapping tool member rotatably attached into a tubular tool body for threading or tapping an inner thread into a work piece or the like and for inserting a coil insert into the inner thread or the screw hole of the work piece.

For example, U.S. Pat. No. 4,768,270 to Czarnowski discloses one of the typical installation tools for use in automatically installing a helical coil insert to a preselected depth in a tapped hole formed in a work piece, and comprising a tubular tool body carrying an insert near its lower end, and a mandrel in threadedly received in the tool body for engaging the insert and rotatably advancing it into the tapped hole.

However, the mandrel includes an outer thread formed therein and may only be used to form a tapped hole or screw hole in the work piece, but may not be used to form an outer thread on the fasteners or the like.

U.S. Pat. No. 5,647,803 to Killer discloses another typical thread cutting device for cutting threads into an unthreaded end of a shaft member, and comprising a cutting blade support member mountable on one side of an elongate frame, and an adjustably movable shaft support mountable on the other side of the elongate frame in opposed relation to the cutting blade support member and movable between a shaft clamping position and a shaft releasing position.

However, the cutting blade support member and the adjustably movable shaft support may only be used to form an outer thread into an unthreaded end of a shaft member, but may not be used to form an inner thread in the work pieces or the like.

U.S. Pat. No. 5,879,112 to Ivey discloses a further typical thread tapping tool for allowing plumbers to tap into a main water supply line.

However, similarly, the typical thread tapping tool may only be used to form a tapped hole in the work piece or the main water supply line, but may not be used to form an outer thread on the outer peripheral portion of the fasteners, the work pieces, the main water supply lines or the like.

U.S. Pat. No. 6,589,122 to Chen discloses a still further typical thread tapping device for cutting or forming outer threads onto a shaft member.

However, similarly, the typical thread tapping device may only be used to form an outer thread into an outer peripheral portion of the shaft member, but may not be used to form an inner thread in the work pieces or the like.

U.S. Pat. No. 6,644,898 to Chu discloses a still further typical thread tapping or repairing device for cutting or forming or repairing threaded mouths or ports.

However, similarly, the typical thread tapping or repairing device may only be used to cut or form an inner thread into the threaded mouths or ports, but may not be used to form an outer thread on the outer peripheral portion of the shaft member or the work pieces or the like.

U.S. Pat. No. 7,587,799 to Li discloses a still further typical thread tapping or repairing or installation tools for use in installing a helical coil insert to a preselected depth in a tapped hole formed in a work piece.

However, similarly, the typical thread tapping or repairing or installation tool may only be used to cut or form a tapped hole in the work piece, but may not be used to form an outer thread on the fasteners or the like.

The present invention has arisen to mitigate and/or obviate the afore-described disadvantages of the conventional thread tapping tools.

### SUMMARY OF THE INVENTION

The primary objective of the present invention is to provide a thread tapping tool including a combination or structure for threading or tapping either the inner thread or the outer thread on the fasteners.

The other objective of the present invention is to provide a thread tapping tool including a combination or structure for allowing the inner thread tapping device or the outer thread tapping device to be easily and quickly attached to or disengaged from the tool housing and to be easily changed with each other or operated by the users.

In accordance with one aspect of the invention, there is provided a thread tapping tool comprising a housing including a chamber formed therein, an inner thread tapping device including a cartridge having a gear wheel for selectively or changeably engaging into the chamber of the housing, and including a tapping mandrel for an inner thread tapping or forming purpose, an outer thread tapping device including a carrier having a gear wheel for selectively or changeably engaging into the chamber of the housing, and including a thread cutting member having a thread cutter blade for an outer thread tapping or forming purpose, a lock device for selectively and detachably locking either the cartridge of the inner thread tapping device or the carrier of the outer thread tapping device to the housing, and a switch device including a pivotal pawl having two toothed engaging members for selectively engaging with either of the gear wheels of the cartridge and the carrier and for controlling a driving direction of either the cartridge or the carrier by the housing and for allowing the inner thread tapping device and the outer thread tapping device to selectively tap or form an inner thread in a work piece with a tapping mandrel or to selectively tap or form an outer thread in the shaft members or the other work pieces.

The housing includes an inner peripheral recess formed therein and communicative with the chamber of the housing, and the lock device includes a retaining ring received and engaged in the inner peripheral recess of the housing for selectively engaging with either the cartridge of the inner thread tapping device or the carrier of the outer thread tapping device and detachably locking either the cartridge of the inner thread tapping device or the carrier of the outer thread tapping device to the housing.

The housing includes a passage formed therein and communicative with the chamber of the housing, and the lock device includes a detent slidably received and engaged in the passage of the housing and engaged with the retaining ring for selectively forcing the retaining ring to detachably engage with either the cartridge of the inner thread tapping device or the carrier of the outer thread tapping device.

The housing includes an orifice formed therein and communicative with the passage of the housing, and the lock device includes a button slidably received and engaged in the orifice of the housing for selectively engaging with the detent and for selectively forcing the retaining ring to detachably engage with either the cartridge of the inner thread tapping device or the carrier of the outer thread tapping device.

The button includes an actuator provided on the button for selectively engaging with the detent and for selectively forcing the retaining ring to detachably engage with either the cartridge of the inner thread tapping device or the carrier of the outer thread tapping device.

The button includes an outer end extended out of the housing, and the lock device includes a spring biasing member engaged with the button for biasing and forcing the actuator to engage with the detent and to force and move the outer end of the button out of the housing and for allowing the outer end of the button to be depressed by the user onto the spring biasing member.

The housing includes a compartment formed therein and communicative with the chamber of the housing, and the switch device includes a pawl received and engaged in the compartment of the housing and pivotally mounted to the housing with a pivot axle, and includes two engaging members for selectively engaging with either of the gear wheels of the cartridge or the carrier and for determining a rotating direction of either the cartridge or the carrier by the housing.

The housing includes a first end, a handle pivotally coupled to the first end of the housing and having a cavity formed in the handle, and a spring biased projection engaged in the handle and extendible out of the handle for engaging with the pawl and for actuating either of the engaging members to selectively engage with either of the gear wheels of the cartridge or the carrier and to control or determine the rotating direction of either the cartridge or the carrier by the housing.

The housing includes a screw hole formed in the first end thereof and communicative with the compartment of the housing, and the handle includes a threaded segment for engaging with the screw hole of the housing and for detachably attaching the handle to the housing. The carrier includes a space formed therein for mounting the thread cutting member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a thread tapping tool in accordance with the present invention;

FIG. 2 is another partial exploded view of the thread tapping tool;

FIG. 3 is a further partial exploded view of the thread tapping tool;

FIG. 4 is a still further partial exploded view of the thread tapping tool;

FIGS. 5, 6 are partial perspective views illustrating the operation of the thread tapping tool;

FIG. 7 is a partial cross sectional view of the thread tapping tool taken along lines 7-7 of FIG. 1;

FIG. 8 is an enlarged partial cross sectional view of the thread tapping tool;

FIGS. 9, 10 are further enlarged partial cross sectional views illustrating the operation of the thread tapping tool;

FIGS. 11, 12 are partial cross sectional views of the thread tapping tool taken along lines 11-11, 12-12 of FIGS. 9 and 10 respectively;

FIGS. 13, 14 are further partial cross sectional views similar to FIGS. 11, 12, illustrating the operation of the thread tapping tool; and

FIGS. 15, 16 are perspective views illustrating the further operation of the thread tapping tool.

### DETAILED DESCRIPTION OF THE PREFERRED EMBODIMENT

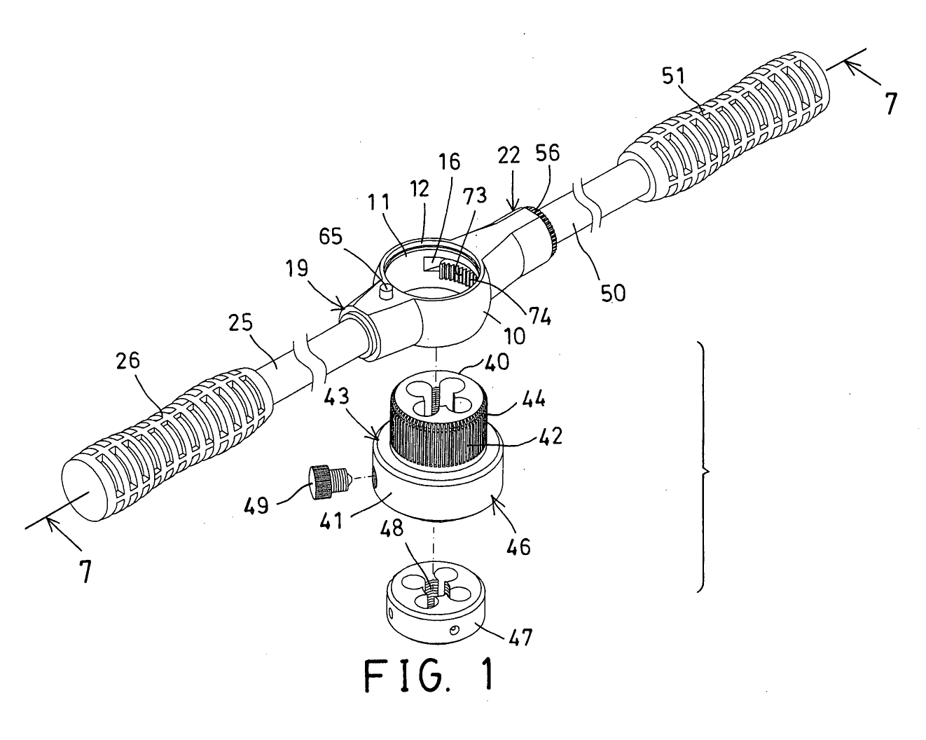

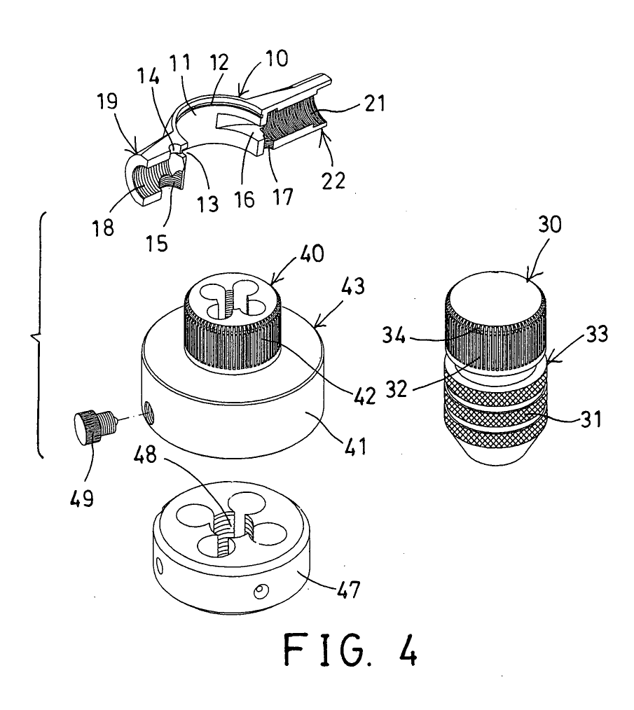

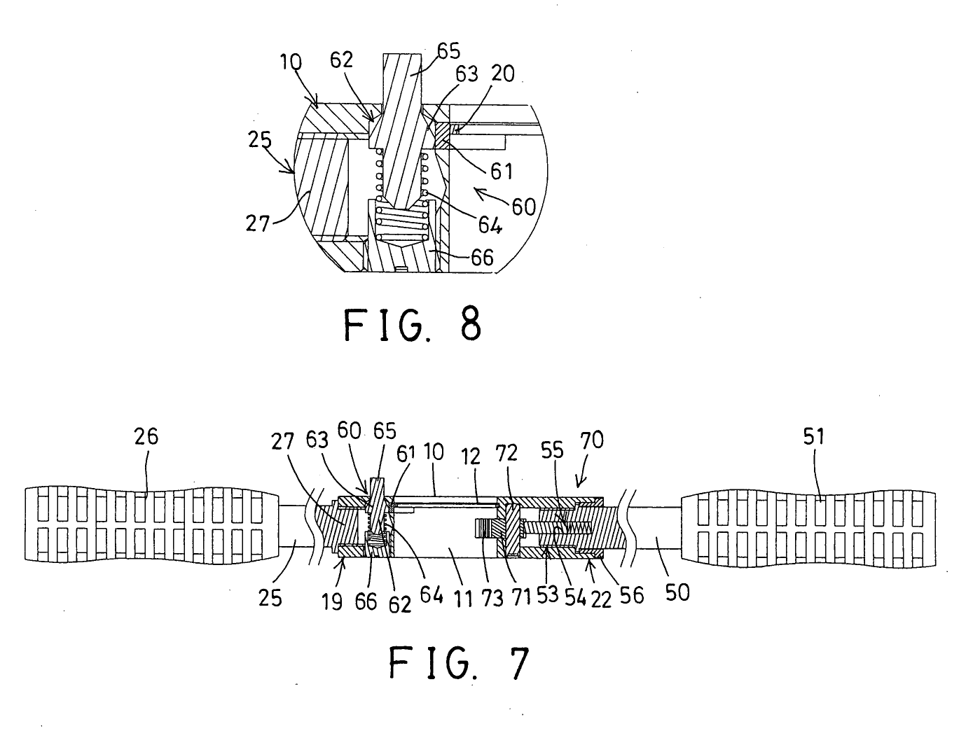

Referring to the drawings, and initially to FIGS. 1-7, a thread tapping tool in accordance with the present invention comprises a tool body or tool head or carrier or housing 10 including a chamber 11 formed therein for selectively or changeably receiving or attaching or engaging with either an inner thread tapping device 30 or an outer thread tapping device 40, and including an inner peripheral recess 12 formed therein and communicative with the chamber 11 of the housing 10 for receiving or engaging with a clamping ring or retaining ring 20, and including a passage 13 and an orifice 14 formed therein, in which the orifice 14 is arranged substantially parallel to the chamber 11 of the housing 10, and the passage 13 is located between the orifice 14 and the chamber 11 of the housing 10 and communicative with the orifice 14 and the chamber 11 of the housing 10.

The housing 10 further includes an inner thread or a screw hole 15 formed therein and aligned with and communicative with the orifice 14 of the housing 10, and includes a compartment 16 formed therein and communicative with the chamber 11 of the housing 10, and includes another screw hole 17 formed therein and communicative with the compartment 16 of the housing 10, and includes a further screw hole 18 formed in one end portion 19 thereof for threading or engaging with or attaching a handle 25, and includes a still further screw hole 21 formed in the other end portion 22 thereof for threading or engaging with or attaching another handle 50, in which the screw hole 21 at the other end portion 22 of the housing 10 is communicative with the screw hole 17 and/or the compartment 16 of the housing 10.

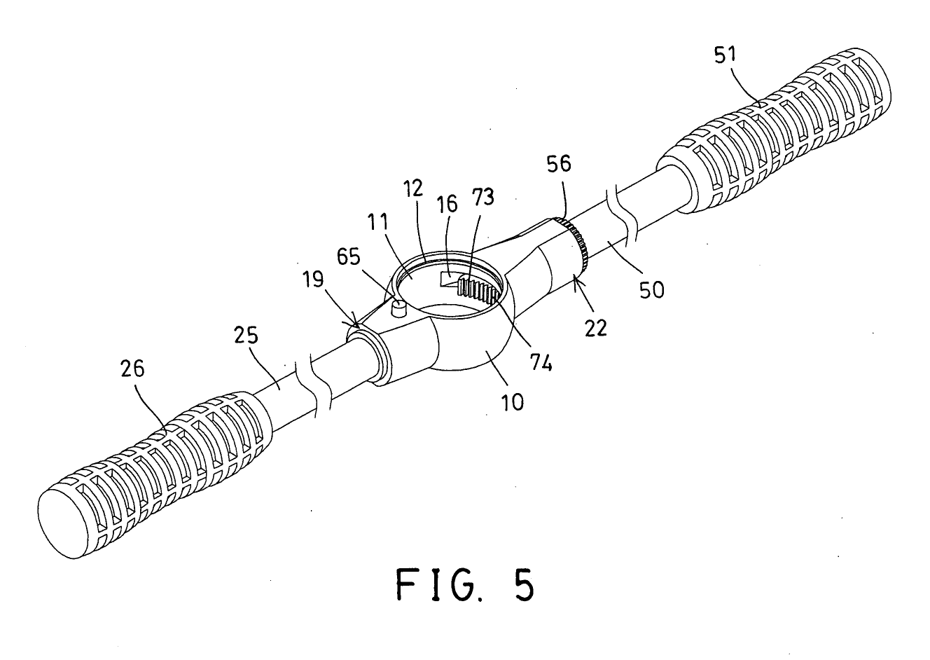

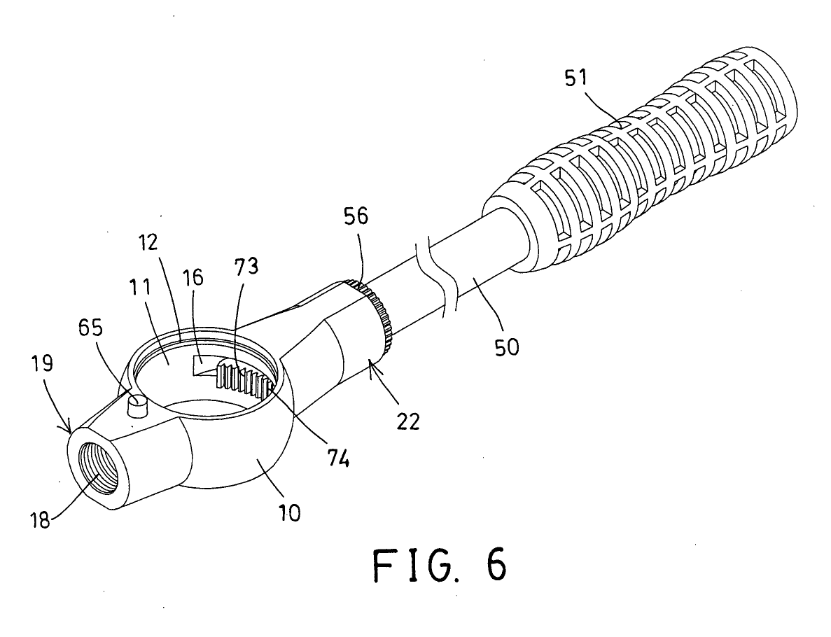

The handle 25 includes a soft or resilient hand grip 26 formed or provided thereon for being comfortably held or grasped by the user, and a threaded segment 27 formed or provided on one end thereof for threading or engaging with the screw hole 18 of the housing 10 and for selectively or optionally or detachably attaching the handle 25 to the housing 10 (FIGS. 5, 6) and for rotating or driving the housing 10 with a greatly increased driving torque. The other handle 50 also includes a soft or resilient hand grip 51 formed or provided thereon for being comfortably held or grasped by the user, and a threaded segment 52 formed or provided on one end 53 thereof for threading or engaging with the screw hole 21 of the housing 10 and for selectively or optionally or detachably attaching the handle 50 to the housing 10 and for rotating or driving the housing 10 with a greatly increased driving torque.

The handle 50 further includes a cavity 54 formed in the one end 53 thereof and arranged substantially parallel to the longitudinal axis or direction of the handle 50 for receiving or engaging with a spring biased projection 55 which is extendible into the screw hole 17 and/or the compartment 16 of the housing 10. A lock nut 56 is threaded and attached or mounted to the other end portion 22 of the housing 10 and engaged with an outer peripheral flange 57 of the handle 50 for pivotally or rotatably attaching or coupling or mounting or anchoring or securing the handle 50 to the housing 10 and arranged for allowing the handle 50 to be rotated relative to the housing 10 for about 360 degrees in total or for about 180 degrees for each direction, and arranged for allowing the spring biased projection 55 to be pivoted or rotated or moved relative to the housing 10.

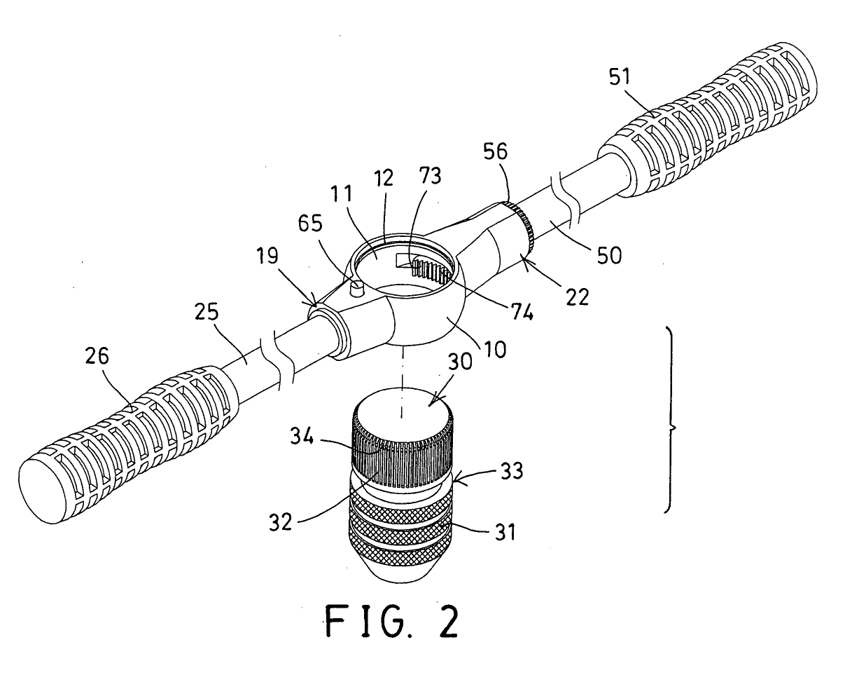

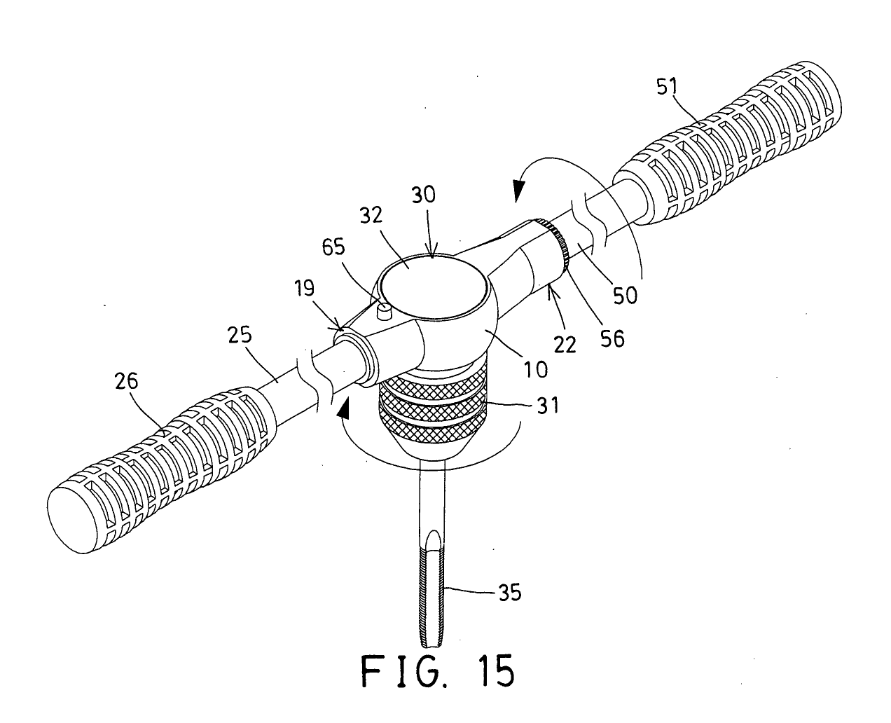

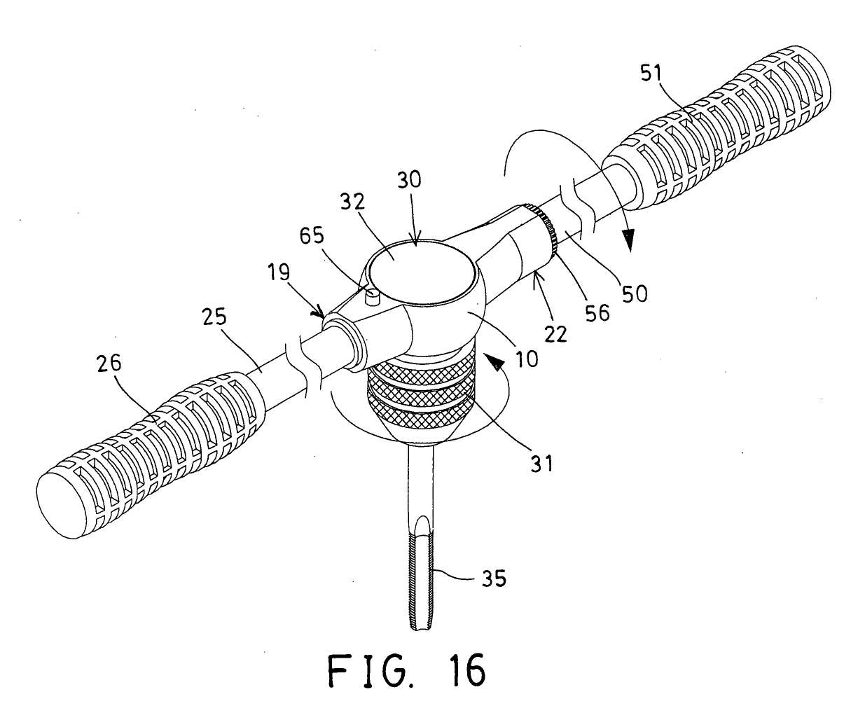

As shown in FIGS. 2, 4 and 15-16, the inner thread tapping device 30 includes a carrier or cartridge 31 having a gear wheel 32 formed or provided on one end or the upper end 33 thereof for engaging into the chamber 11 of the housing 10, and includes an outer peripheral groove 34 formed therein for selectively receiving or engaging with the clamping ring or retaining ring 20 (FIGS. 9-12) and for detachably attaching or mounting or anchoring or securing the cartridge 31 of the inner thread tapping device 30 to the housing 10, the cartridge 31 is provided for attaching or mounting or securing or supporting a tapping mandrel 35 which may be used for selectively tapping or forming an inner thread in the work piece (not shown) or the like.

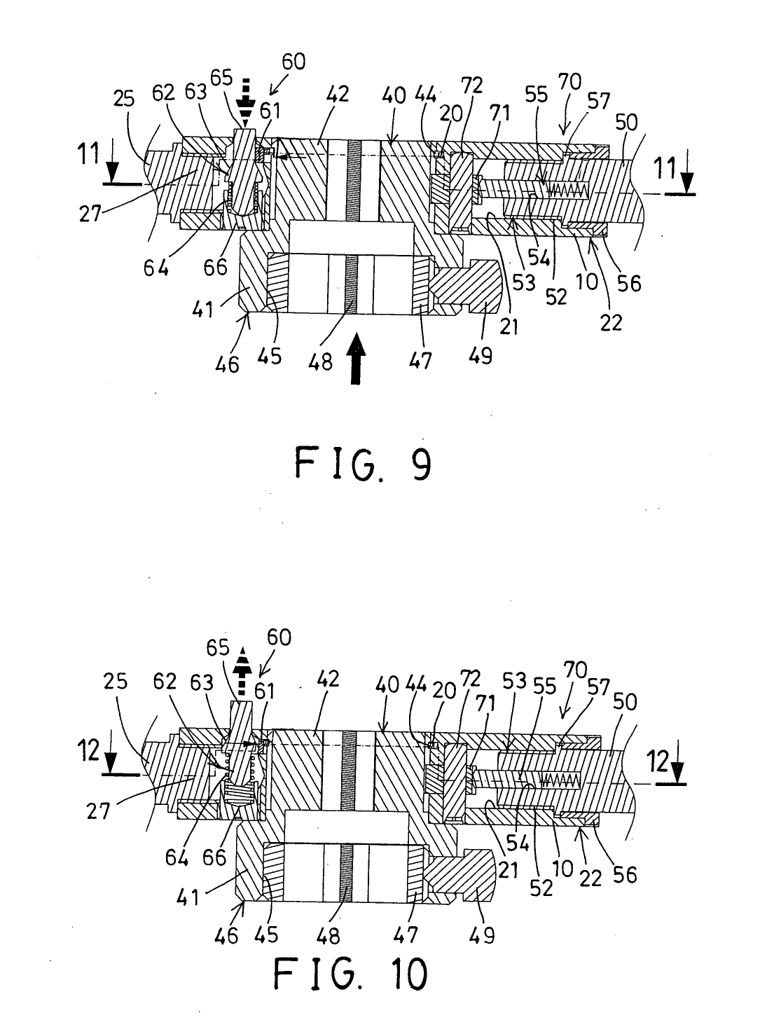

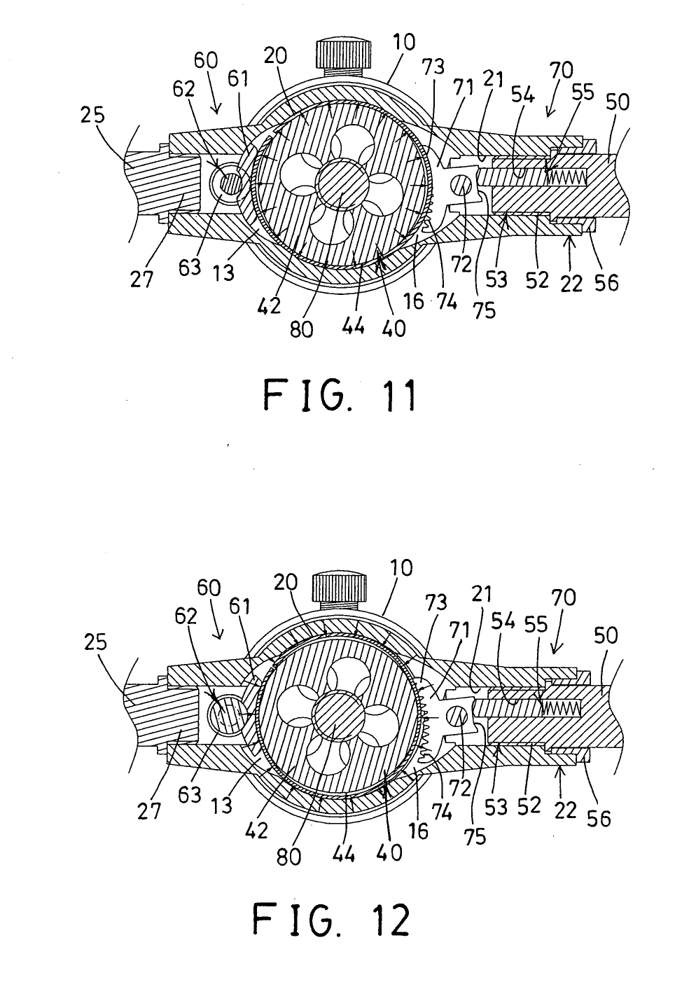

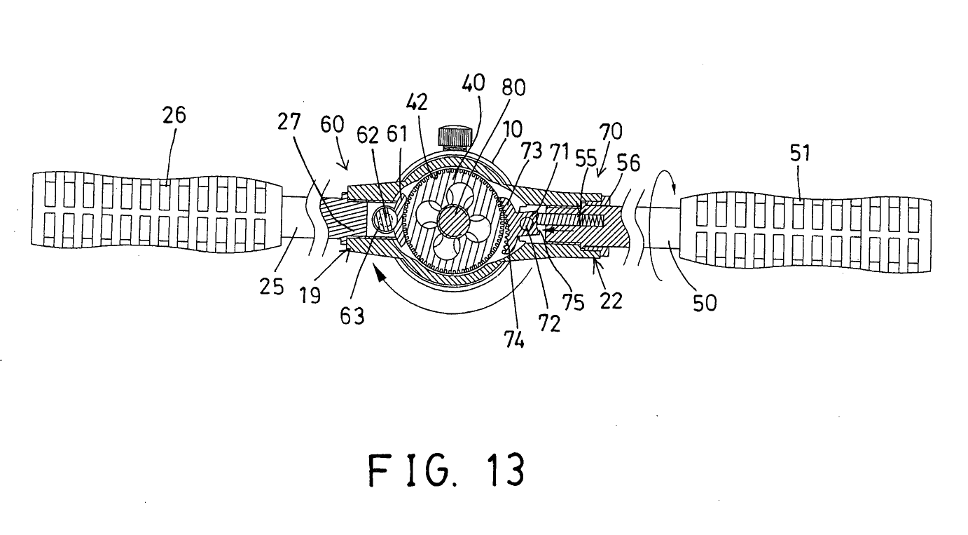

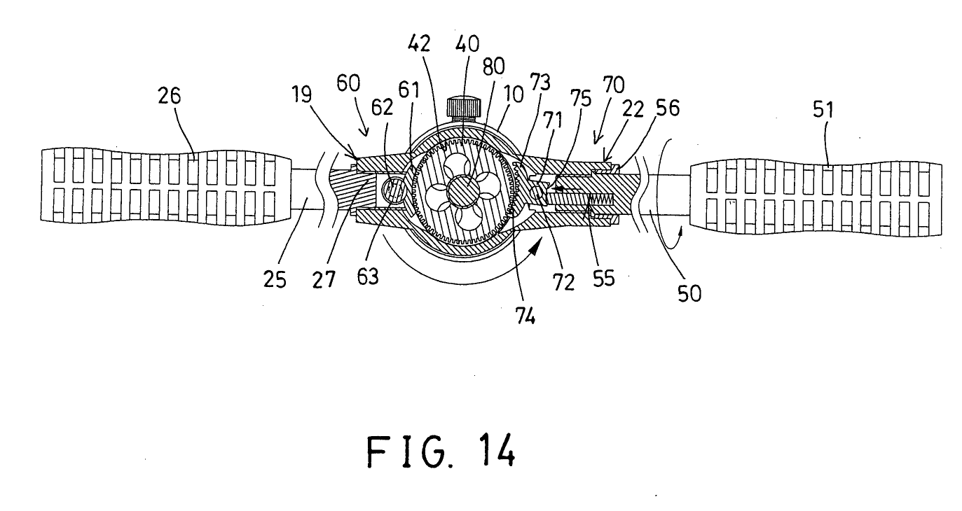

As shown in FIGS. 1, 4 and 9-14, the outer thread tapping device 40 includes a cartridge or carrier 41 having a gear wheel 42 formed or provided on one end or the upper end 43 thereof for engaging into the chamber 11 of the housing 10, and includes an outer peripheral groove 44 formed therein for selectively receiving or engaging with the clamping ring or retaining ring 20 (FIGS. 9-12) and for detachably attaching or mounting or anchoring or securing the carrier 41 of the outer thread tapping device 40 to the housing 10, the carrier 41 includes a space 45 formed in the lower portion 46 thereof (FIGS. 9, 10) and provided for attaching or mounting or securing or supporting a tapping or thread cutting member 47 which includes a thread cutter blade 48 formed therein that may be used for selectively tapping or forming an outer thread in the outer peripheral portion of the shaft member 80 (FIGS. 11-14) or the other work pieces (not shown) or the like.

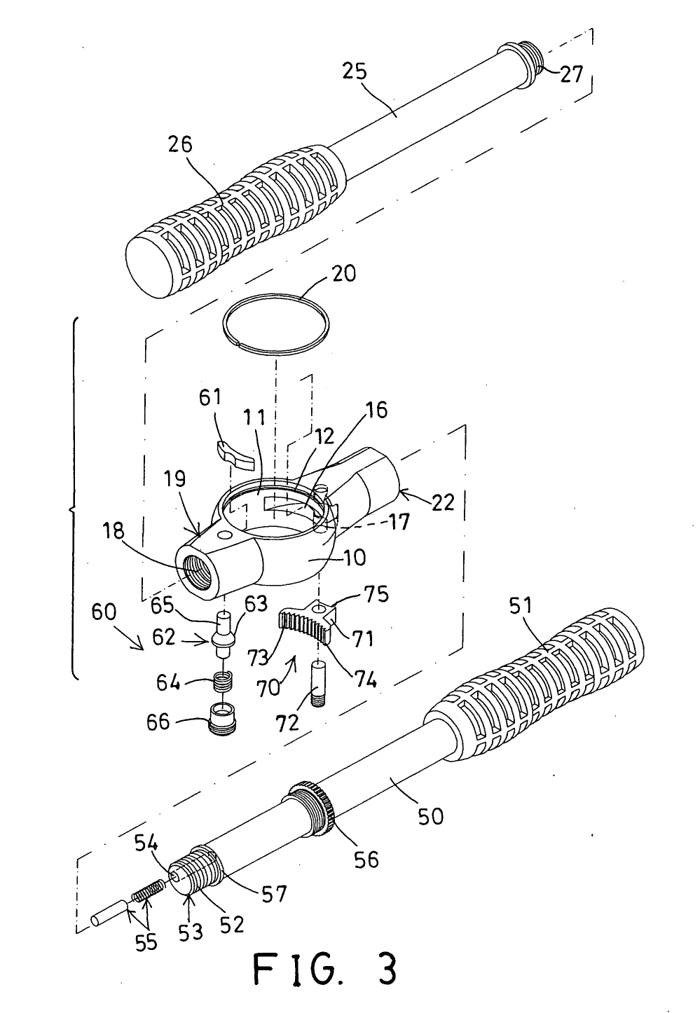

As shown in FIGS. 3-4 and 7-14, a quick-release lock device 60 is further provided and includes a detent 61 slidably received or engaged with the passage 13 of the housing 10 and contacted or engaged with the retaining ring 20 for selectively forcing or actuating the retaining ring 20 to detachably engage with either the cartridge 31 of the inner thread tapping device 30 or the carrier 41 of the outer thread tapping device 40, and includes a button 62 slidably received or engaged with the orifice 14 of the housing 10, and includes an outer peripheral bulge or actuator 63 formed or provided on the button 62 for selectively engaging with the detent 61 and for selectively forcing or moving or actuating the retaining ring 20 to detachably engage with either the cartridge 31 of the inner thread tapping device 30 or the carrier 41 of the outer thread tapping device 40.

The lock device 60 may further include a spring biasing member 64 engaged with the button 62 or the actuator 63 for biasing or forcing the actuator 63 or the button 62 to engage with the detent 61 and to selectively force or move or actuate the retaining ring 20 to detachably engage with either the cartridge 31 of the inner thread tapping device 30 or the carrier 41 of the outer thread tapping device 40. The button 62 includes an outer or upper end 65 extended out of the housing 10 for being depressed by the user (FIG. 9) onto or against the spring biasing member 64 and for selectively disengaging the actuator 63 of the button 62 from the detent 61, and thus for disengaging the retaining ring 20 from the cartridge 31 of the inner thread tapping device 30 or the carrier 41 of the outer thread tapping device 40.

In operation, as shown in FIGS. 9 and 11, when the actuator 63 of the button 62 is disengaged from the detent 61 and when the retaining ring 20 is disengaged from the cartridge 31 of the inner thread tapping device 30 or the carrier 41 of the outer thread tapping device 40, the cartridge 31 of the inner thread tapping device 30 or the carrier 41 of the outer thread tapping device 40 may be easily and quickly engaged into or disengaged from the chamber 11 of the housing 10, and the retaining ring 20 may be easily and quickly forced to detachably engage with either the cartridge 31 of the inner thread tapping device 30 or the carrier 41 of the outer thread tapping device 40 by the actuator 63 of the button 62 when the button 62 is released. A cap 66 may further be threaded and attached or mounted to the screw hole 15 of the housing 10 for solidly and stably retaining the spring biasing member 64 and the button 62 in the orifice 14 of the housing 10.

A ratchet or switch device 70 is further provided and includes a pawl 71 pivotally or rotatably received or engaged in the compartment 16 of the housing 10 and pivotally or rotatably attached or mounted or coupled to the housing 10 with a pivot axle 72 which is threaded and attached or mounted to the screw hole 17 of the housing 10, and includes two toothed end or engaging members 73, 74 for selectively engaging with either of the gear wheels 32, 42 of the cartridge 31 of the inner thread tapping device 30 and the carrier 41 of the outer thread tapping device 40 and for determining or controlling the rotating or driving direction of either the cartridge 31 of the inner thread tapping device 30 or the carrier 41 of the outer thread tapping device 40 by the housing 10 and/or the handles 25, 50.

For example, the pawl 71 includes a curved depression 75 formed therein (FIGS. 11-14) for receiving or engaging with the spring biased projection 55 which may be pivoted or rotated or moved relative to the housing 10 and the pawl 71 by rotating the handle 50, in order to selectively force or move or actuate either of the toothed engaging members 73, 74 to selectively engage with either of the gear wheels 32, 42 of the cartridge 31 of the inner thread tapping device 30 or the carrier 41 of the outer thread tapping device 40, and thus to determine or control the rotating or driving direction of either the cartridge 31 of the inner thread tapping device 30 or the carrier 41 of the outer thread tapping device 40 by the housing 10 and/or the handles 25, 50.

In operation, as shown in FIGS. 1-2 and 9-16, either the cartridge 31 of the inner thread tapping device 30 or the carrier 41 of the outer thread tapping device 40 may be easily and quickly engaged into or disengaged from the chamber 11 of the housing 10 and may be easily and quickly coupled or locked to the housing 10 with the lock device 60 for selectively tapping or forming an inner thread in the work piece or for selectively tapping or forming an outer thread in the outer peripheral portion of the shaft member 80 (FIGS. 11-14). It is to be noted that the typical thread cutting or forming or tapping devices may only be used to form either an inner thread or an outer thread into a shaft member or work piece, but may not be used to selectively form an inner thread and an outer thread in the work pieces or shaft members or the like with a single thread tapping tool.

Accordingly, the thread tapping tool in accordance with the present invention includes a combination or structure for threading or tapping either the inner thread or the outer thread on the fasteners, and for allowing the inner thread tapping device or the outer thread tapping device to be easily and quickly attached to or disengaged from the tool housing and to be easily changed or operated by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A thread tapping tool comprising:
a housing including a chamber formed therein,
an inner thread tapping device including a cartridge having a gear wheel for selectively or changeably engaging into said chamber of said housing, and including a tapping mandrel for an inner thread tapping or forming purpose,
an outer thread tapping device including a carrier having a gear wheel for selectively or changeably engaging into said chamber of said housing, and including a thread cutting member having a thread cutter blade for an outer thread tapping or forming purpose,
a lock device for selectively and detachably locking either said cartridge of said inner thread tapping device or said carrier of said outer thread tapping device to said housing, and
a switch device including a pivotal pawl having two toothed engaging members for selectively engaging with either of said gear wheels of said cartridge and said carrier and for controlling a driving direction of either said cartridge or said carrier by said housing.

2. The thread tapping tool as claimed in claim 1, wherein said housing includes an inner peripheral recess formed therein and communicative with the chamber of the housing, and said lock device includes a retaining ring received and engaged in said inner peripheral recess of said housing for selectively engaging with either said cartridge of said inner thread tapping device or said carrier of said outer thread tapping device and detachably locking either said cartridge of said inner thread tapping device or said carrier of said outer thread tapping device to said housing.

3. The thread tapping tool as claimed in claim 2, wherein said housing includes a passage formed therein and communicative with said chamber of said housing, and said lock device includes a detent slidably received and engaged in said passage of said housing and engaged with said retaining ring for selectively forcing said retaining ring to detachably engage with either said cartridge of said inner thread tapping device or said carrier of said outer thread tapping device.

4. The thread tapping tool as claimed in claim 3, wherein said housing includes an orifice formed therein and communicative with said passage of said housing, and said lock device includes a button slidably received and engaged in said orifice of said housing for selectively engaging with said detent and for selectively forcing said retaining ring to detachably engage with either said cartridge of said inner thread tapping device or said carrier of said outer thread tapping device.

5. The thread tapping tool as claimed in claim 4, wherein said button includes an actuator provided on said button for selectively engaging with said detent and for selectively forcing said retaining ring to detachably engage with either said cartridge of said inner thread tapping device or said carrier of said outer thread tapping device.

6. The thread tapping tool as claimed in claim 5, wherein said button includes an outer end extended out of the housing, and said lock device includes a spring biasing member engaged with the button for biasing and forcing the actuator to engage with the detent and to force and move said outer end of said button out of the housing.

7. The thread tapping tool as claimed in claim 1, wherein said housing includes a compartment formed therein and communicative with said chamber of said housing, and said switch device includes a pawl received and engaged in said compartment of said housing and pivotally mounted to said housing with a pivot axle, and includes two engaging members for selectively engaging with either of said gear wheels of said cartridge or said carrier and for determining a rotating direction of either said cartridge or said carrier by said housing.

8. The thread tapping tool as claimed in claim 7, wherein said housing includes a first end, a handle pivotally coupled to said first end of said housing and having a cavity formed in said handle, and a projection engaged in said handle and extended out of said handle for engaging with said pawl and for actuating either of said engaging members to selectively engage with either of said gear wheels of said cartridge or said carrier.

9. The thread tapping tool as claimed in claim 8, wherein said housing includes a screw hole formed in said first end thereof and communicative with said compartment of said housing, and said handle includes a threaded segment for engaging with said screw hole of said housing and for detachably attaching said handle to said housing.

10. The thread tapping tool as claimed in claim 1, wherein said carrier includes a space formed therein for mounting said thread cutting member.
